(19) United States
(12) Patent Application Publication
(10) Pub. No.: US 2026/0043978 A1
(43) Pub. Date: Feb. 12, 2026

(54) OPTICAL FIBER CABLE

(71) Applicant: NTT, Inc., Tokyo (JP)

(72) Inventors: Akira Sakurai, Musashino-shi, Tokyo (JP); Soichi ISHIKAWA, Musashino-shi, Tokyo (JP); Masashi KIKUCHI, Musashino-shi, Tokyo (JP); Takashi MATSUO, Musashino-shi, Tokyo (JP); Yusuke Yamada, Musashino-shi, Tokyo (JP); Sadaharu HOMAN, Musashino-shi, Tokyo (JP)

(21) Appl. No.: 18/995,463

(22) PCT Filed: Aug. 2, 2022
(86) PCT No.: PCT/JP2022/029604

§ 371 Date: Jan. 16, 2025

(51) Int. Cl. G02B 6/44

(52) U.S. Cl. CPC G02B 6/4432; G02B 6/4431

(57) ABSTRACT

An optical fiber cable (10A) includes a sheath (11) including an inner peripheral surface (11a) that forms an accommodation space (14), a coated optical fiber (12) accommodated in the accommodation space (14), and a tension members (13) provided in the sheath (11). A part of an outer peripheral surface (13a) of at least one of the tension members (13) is in contact with the inner peripheral surface (11a) of the sheath (11) from an inside of the sheath (11) or exposed from the inner peripheral surface (11a) to the accommodation space (14).

### TECHNICAL FIELD

The present invention relates to an optical fiber cable.

### BACKGROUND ART

Optical fiber cables are frequently used in the construction of optical communication networks. Patent Literature 1 discloses an optical fiber cable in which coated optical fibers are bundled at high density. A tension member is provided in the sheath of the optical fiber cable to prevent damage due to excessive bending of the coated optical fiber and suppress an increase in transmission loss. Note that, as disclosed in Patent Literature 2, a tension members is used in some cases.

### CITATION LIST

### Patent Literature

Patent Literature 1: JP 4774337 B
Patent Literature 2: JP 6182091 B

### SUMMARY OF THE INVENTION

### Technical Problem

When the coated optical fiber accommodated in the optical fiber cable is taken out, it is necessary to remove the sheath to expose the coated optical fiber. In order to facilitate incision of the sheath at the time of such work, a tearing cord is provided in the sheath.

Unlike the tension member, the tearing cord does not have strength that contributes to the mechanical strength of the optical fiber cable. Therefore, the portion of the sheath where the tearing cord is provided is more likely to be weaker against an external force than the portion where the tearing cord is not provided.

The present invention has been made in view of the above circumstances, and an object of the present invention is to provide an optical fiber cable that is easy to take out and is less likely to occur a portion in a sheath, which is vulnerable to an external force.

### Solution to Problem

An optical fiber cable according to one aspect of the present invention includes: a sheath including an inner peripheral surface that forms an accommodation space; a coated optical fiber accommodated in the accommodation space; and tension members provided in the sheath, wherein a part of an outer peripheral surface of at least one of the tension members is in contact with the inner peripheral surface of the sheath from an inside of the sheath or exposed from the inner peripheral surface to the accommodation space.

### Advantageous Effects of Invention

According to the present invention, it is possible to provide an optical fiber cable which is easy to take out and is less likely to occur a portion in a sheath, which is vulnerable to an external force.

### BRIEF DESCRIPTION OF DRAWINGS

FIG. 1 is a cross-sectional view of an optical fiber cable according to a first embodiment.

FIG. 2A is a perspective view of a first example, which enlarges cross sections of a part of the sheath and the tension member according to each embodiment.

FIG. 2B is a perspective view of a second example, which enlarges cross sections of a part of the sheath and a cross section of the tension member according to each embodiment.

FIG. 3 is a cross-sectional view of an optical fiber cable according to a modification of the first embodiment.

FIG. 4 is a cross-sectional view of an optical fiber cable according to a second embodiment.

FIG. 5 is a cross-sectional view of an optical fiber cable according to a third embodiment.

FIG. 6 is a cross-sectional view of an optical fiber cable according to a fourth embodiment.

### DESCRIPTION OF EMBODIMENTS

Hereinafter, optical fiber cables according to some embodiments of the present invention will be described. Note that portions common in the drawings are denoted by the same reference numerals, and redundant description will be omitted. In addition, the following embodiments can be combined.

### First Embodiment

First, a first embodiment will be described.

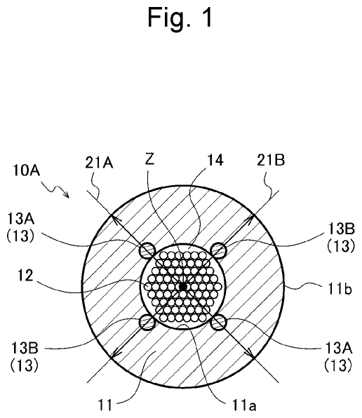

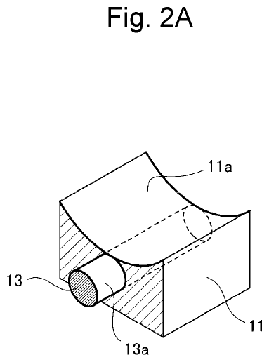

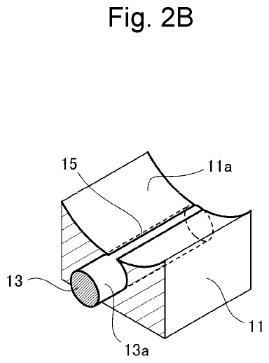

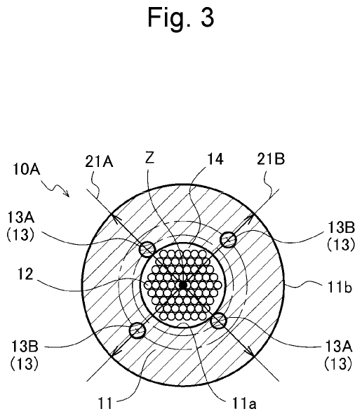

FIG. 1 is a cross-sectional view of an optical fiber cable 10A according to the present embodiment. FIG. 2A is a perspective view of a first example, which enlarges cross sections of a sheath 11 and a tension member 13 according to the present embodiment. FIG. 2B is a perspective view of a second example of the same. Note that FIGS. 2A and 2B are also applied to other embodiments described later. FIG. 3 is a cross-sectional view of the optical fiber cable 10A according to a modification of the present embodiment.

As illustrated in FIG. 1, the optical fiber cable 10A includes the sheath 11, one or more coated optical fibers 12, and a the tension members 13. The sheath 11 is a tubular member formed of synthetic resin and extending in one direction. The sheath 11 includes an inner peripheral surface 11a and an outer peripheral surface 11b. The inner peripheral surface 11a forms an accommodation space 14 of the coated optical fiber 12. The outer peripheral surface 11b forms an outer shape of the sheath 11. The sheath 11 accommodates the coated optical fiber 12 in the accommodation space 14 and protects the coated optical fiber 12. The material of the sheath 11 is, for example, a polyolefin-based synthetic resin such as polyethylene.

The type and number of the coated optical fiber 12 are arbitrary. For example, the coated optical fiber 12 may be a single-core optical fiber or a multi-core optical fiber ribbon. Further, the coated optical fibers 12 may be bundled with a press-winding tape or the like.

The tension members 13 are provided on the sheath 11. The tension members 13 bear tension applied to the optical fiber cable 10A, and prevent damage to the optical fiber cable 10A and thus damage to the coated optical fiber 12. The material of the tension members 13 is, for example, fiber reinforced plastic (FRP) using aramid fibers, glass fibers, or the like, or steel wires. However, the material of the tension members 13 is not limited to the above as long as desired performance is obtained.

As illustrated in FIG. 1, the tension members 13 forms, for example, pairs located at symmetrical positions with respect to a central axis Z of the sheath 11. In the example illustrated in FIG. 1, two tension members 13A and 13A form one pair, and two tension members 13B and 13B form the other pair. A plane 21A including the tension members 13A and 13A and a plane 21B including the tension members 13B and 13B intersect each other at a predetermined angle (for example, 90°). That is, the tension members 13 are disposed at symmetrical positions with respect to the central axis Z or a plane including the central axis Z.

In the present embodiment, a part of an outer peripheral surface 13a of at least one of the tension members 13 is in contact with the inner peripheral surface 11a of the sheath 11 from the inside of the sheath 11 (see FIG. 2A), or is exposed from the inner peripheral surface 11a to the accommodation space 14 (see FIG. 2B). In the example illustrated in FIG. 1, all of the tension members 13 constituting pairs are in contact with the inner peripheral surface 11a of the sheath 11 from the inside of the sheath 11 or exposed from the inner peripheral surface 11a to the accommodation space 14.

As illustrated in FIG. 2A, the minimum interval between the outer peripheral surface 13a of the tension member 13 and the inner peripheral surface 11a of the sheath 11 is extremely narrow, for example, about 0 to 0.1 mm, but it is preferably about 0 to 0.01 mm at which tearing is facilitated. Alternatively, as illustrated in FIG. 2B, when the outer peripheral surface 13a of the tension member 13 is exposed to the accommodation space 14, a slit 15 is formed in the inner peripheral surface 11a of the sheath 11. The width of the slit 15 is about ¼ of the diameter of the tension member 13 at the most. In either case, the tension member 13 is firmly bonded to the sheath 11 to such an extent that the tension member 13 is not detached from the sheath 11 by deformation of the optical fiber cable 10A such as bending.

The optical fiber cable 10A according to the present embodiment does not have a tearing cord. Therefore, when the coated optical fiber 12 is taken out from the optical fiber cable 10A, the sheath 11 is scraped with a tool such as a blade, and the tension member 13 is exposed from the scraped portion. Thereafter, by peeling the exposed tension member 13 off from the sheath 11, the sheath 11 tears in the longitudinal direction. As a result, the coated optical fiber 12 can be taken out from the portion where the sheath 11 is torn.

In the optical fiber cable 10A according to the present embodiment, no tearing cord is provided on the sheath 11. Therefore, a portion vulnerable to external force is less likely to occur in the sheath 11.

When the tension members 13 are provided as pairs positioned symmetrically with respect to the central axis Z of the sheath 11, the distances of the tension members 13 with respect to the central axis Z may be different for each of the pairs. That is, the interval between paired tension members 13 and 13 provided symmetrically with respect to the central axis Z may be different for each of the pairs. For example, as illustrated in FIG. 3, the outer peripheral surface 13a of each of the tension members 13A and 13A may be in contact with the inner peripheral surface 11a of the sheath 11 or may be exposed from the inner peripheral surface 11a to the accommodation space 14, while the tension members 13B and 13B may be wholly provided inside the sheath 11.

In this case, the tension members 13B and 13B are located at positions farther away from the central axis Z than the tension members 13A and 13A. In other words, in the cross section orthogonal to the central axis Z, the interval between the two tension members 13B and 13B is larger than the interval between the two tension members 13A and 13A. Such a difference in position causes a difference between the flexural rigidity of the plane 21A including the tension members 13A and 13A and the flexural rigidity of the plane 21B including the tension members 13B and 13B. Due to the difference in flexural rigidity, an operator or the like can specify the position of the tension member 13 that is in contact with the inner peripheral surface 11a of the sheath 11 from the inside of the sheath 11 or exposed from the inner peripheral surface 11a to the accommodation space 14.

### Second Embodiment

Next, a second embodiment will be described.

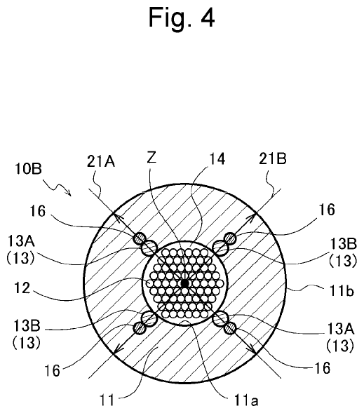

FIG. 4 is a cross-sectional view of an optical fiber cable 10B according to the present embodiment. As illustrated in this drawing, in the optical fiber cable 10B according to the present embodiment, tearing cords 16 are provided in the sheath 11 to be in contact with respective tension members 13. Since other configurations are similar to those of the first embodiment, the description thereof will be omitted.

The tearing cord 16 is a string-like member formed of synthetic resin such as nylon (registered trademark) or polyester. The tearing cord 16 can be exposed by scraping out the sheath 11 with a tool such as a blade. The tension member 13 is exposed by drawing out the exposed tearing cord 16. The exposed tension member 13 can be easily peeled off from the sheath 11. As a result, the sheath 11 tears in the longitudinal direction, and the coated optical fiber 12 can be taken out from the torn portion.

In the present embodiment, the tearing cord 16 is provided in the sheath 11 in a state of being in contact with the tension member 13. In other words, the tearing cord 16 is interposed between the sheath 11 and the tension member 13. Accordingly, the adhesive force between the sheath 11 and the tension member 13 is reduced. Even if the tension member 13 is formed of a material, such as fiber-reinforced plastic, which is easily frayed, it is possible to suppress the occurrence of fraying or unexpected breakage of the tension member 13 when the tension member 13 is pulled out, and it is possible to take out the coated optical fiber 12. In addition, since the tearing cords 16 is close to the tension member 13, a portion vulnerable to external force is less likely to occur in the sheath 11.

### Third Embodiment

Next, a third embodiment will be described.

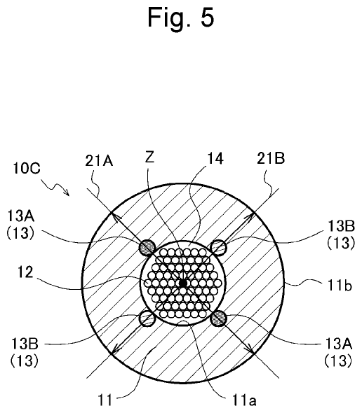

FIG. 5 is a cross-sectional view of an optical fiber cable 10C according to the present embodiment. In the optical fiber cable 10C according to the present embodiment, all of the tension members 13 have the same outer diameter, while the tension members 13 are provided as pairs positioned symmetrically with respect to the central axis Z of the sheath 11, and materials of the tension members 13 are different for each of the pairs. Since other configurations are similar to those of the first embodiment, the description thereof will be omitted.

In the example illustrated in FIG. 5, the tension members 13 are divided into one pair of tension members 13A and 13A and the other pair of tension members 13B and 13B. The tension members 13A and 13A are located at symmetrical positions with respect to the central axis Z, and the tension members 13B and 13B are also located at symmetrical positions with respect to the central axis Z. The plane 21A including the tension members 13A and 13A and the plane 21B including the tension members 13B and 13B intersect at a predetermined angle (for example, 90°) as in other embodiments.

In the present embodiment, the material of the tension member 13A is different from the material of the tension member 13B. Therefore, there is a difference in flexural rigidity between the tension member 13A and the tension member 13B. As a result, a difference is caused between the flexural rigidity of the plane 21A including the tension members 13A and 13A and the flexural rigidity of the plane 21B including the tension members 13B and 13B. Due to the difference in flexural rigidity, the operator or the like can specify the position of the tension member 13 that is in contact with the inner peripheral surface 11a of the sheath 11 from the inside of the sheath 11 or exposed from the inner peripheral surface 11a to the accommodation space 14.

In the present embodiment, no tearing cord is provided on the sheath 11. Therefore, a portion vulnerable to external force is less likely to occur in the sheath 11.

### Fourth Embodiment

Next, a fourth embodiment will be described.

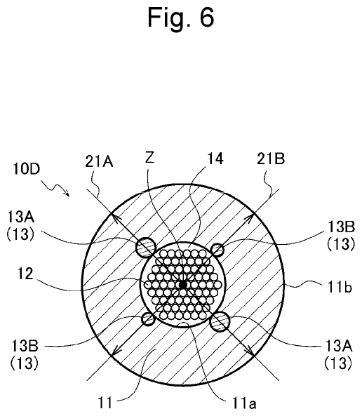

FIG. 6 is a cross-sectional view of an optical fiber cable 10D according to the present embodiment. As illustrated in this drawing, in the optical fiber cable 10D according to the present embodiment, all of the tension members 13 are formed of the same material, while the tension members 13 are provided as pairs positioned symmetrically with respect to the central axis Z of the sheath 11, and the outer diameters of the tension members 13 are different for each of the pairs. Since other configurations are similar to those of the first embodiment, the description thereof will be omitted.

In the example illustrated in FIG. 6, the tension members 13 are divided into one pair of tension members 13A and 13A and the other pair of tension members 13B and 13B. The tension members 13A and 13A are located at symmetrical positions with respect to the central axis Z, and the tension members 13B and 13B are also located at symmetrical positions with respect to the central axis Z. The plane 21A including the tension members 13A and 13A and the plane 21B including the tension members 13B and 13B intersect at a predetermined angle (for example, 90°) as in other embodiments.

In the present embodiment, the outer diameter of the tension member 13A is different from the outer diameter of the tension member 13B. Therefore, there is a difference in flexural rigidity between the tension member 13A and the tension member 13B. As a result, a difference is caused between the flexural rigidity of the plane 21A including the tension members 13A and 13A and the flexural rigidity of the plane 21B including the tension members 13B and 13B. Due to the difference in flexural rigidity, the operator or the like can specify the position of the tension member 13 that is in contact with the inner peripheral surface 11a of the sheath 11 from the inside of the sheath 11 or exposed from the inner peripheral surface 11a to the accommodation space 14.

As in the first and third embodiments, also in the present embodiment, no tearing cord is provided on the sheath 11. Therefore, a portion vulnerable to external force is less likely to occur in the sheath 11.

In any of the embodiments, the sheath 11 can be torn by cutting the sheath 11 to expose the tension member 13 and drawing out the exposed tension member 13. In the embodiment in which the difference in flexural rigidity can be confirmed, the position of the tension member 13 can be specified by bending the optical fiber cable in a directions. Therefore, it is not necessary to provide undulation such as an intentional protrusion indicating a position to be cut on the outer peripheral surface 11b of the sheath 11. Therefore, handling of the optical fiber cable in laying work or the like can be improved.

### REFERENCE SIGNS LIST

10A Optical fiber cable
10B Optical fiber cable
10C Optical fiber cable
10D Optical fiber cable
11 Sheath
11a Inner peripheral surface
11b Outer peripheral surface
12 Coated optical fiber
13 Tension member
13a Outer peripheral surface
13A Tension member
13B Tension member
14 Accommodation space
15 Slit
16 Tearing cord
21A Plane
21B Plane
Z Central axis

1. An optical fiber cable comprising:
a sheath including an inner peripheral surface that forms an accommodation space;
a coated optical fiber accommodated in the accommodation space; and
tension members provided in the sheath,
wherein a part of an outer peripheral surface of at least one of the tension members is in contact with the inner peripheral surface of the sheath from an inside of the sheath or exposed from the inner peripheral surface to the accommodation space.

2. The optical fiber cable according to claim 1, further comprising
a tearing cord provided in the sheath and in contact with each of the tension members.

3. The optical fiber cable according to claim 1, wherein
all of the tension members have a same outer diameter, and
the tension members are provided as pairs positioned symmetrically with respect to a central axis of the sheath, and materials of the tension members are different for each of the pairs.

4. The optical fiber cable according to claim 1, wherein
all of the tension members are formed of a same material, and
the tension members are provided as pairs positioned symmetrically with respect to a central axis of the sheath, and outer diameters of the tension members are different for each of the pairs.

5. The optical fiber cable according to claim 1, wherein
the tension members are provided as pairs positioned symmetrically with respect to a central axis of the sheath, and
distances of the tension members with respect to the central axis are different for each of the pairs.
